(19) United States
(12) Patent Application Publication
(10) Pub. No.: US 2009/0018277 A1
(43) Pub. Date: Jan. 15, 2009

(54) RESIN COMPOSITION EXCELLENT IN HEAT RESISTANCE AND ADHESIVENESS, AND METHOD FOR PRODUCING SAME

(75) Inventors: Syuji Okamoto, Saitama (JP); Hiroto Matsumoto, Saitama (JP); Jun Izumi, Saitama (JP)

Correspondence Address: HAHN & VOIGHT PLLC, 1012 14TH STREET, NW, SUITE 620, WASHINGTON, DC, 20005, US

(73) Assignee: SOKEN CHEMICAL & ENGINEERING CO., LTD., Tokyo (JP)

(21) Appl. No.: 11/913,456

(22) PCT Filed: May 1, 2006
(86) PCT No.: PCT/JP2006/309439

§ 371 Date: Dec. 27, 2007

(30) Foreign Application Priority Data
May 2, 2005 (JP) 2005-133830

(51) Int. Cl. C08L 77/00

(52) U.S. Cl. 525/424; 525/431; 525/426; 525/430

(57) ABSTRACT

Disclosed is a resin composition composed of a heat-treated resin component (A) obtained by heating and mixing an aromatic imide resin or an aromatic imidazole resin with a carboxylic acid anhydride, and a silane compound (B) having at least one functional group selected from the group consisting of an epoxy group, an amino group, an amide group, a methoxy group, an isocyanate group, a carboxyl group, a mercapto group, a vinyl group, a (poly)sulfide group and a methacrylo group. This resin composition has excellent heat resistance of aromatic imide resins and aromatic imidazole resins while being remarkably improved in adhesion to various bases.

### TECHNICAL FIELD

The present invention relates to a resin composition comprising, as a chief component, an aromatic imide resin or a benzoimidazole resin, and a method for producing the same.

### BACKGROUND ART

Aromatic imide resins and aromatic imidazole resins are representative heat-resistant resins, and exhibit the most excellent heat resistance among various resins, undergoing little change in the properties against the temperature, and featuring excellent shock resistance, sliding property, dimensional stability, electric insulation, abrasion resistance, resistance against chemicals and resistance against solvents. Owing to the above features, these resins have been used in the electric and electronic fields such as insulating materials, sealing materials and printed boards, as well as mechanical members for aircraft and space applications where heat resistance is particularly required. In recent years, further, the above resins have been used as materials for forming liquid crystalline orientated films.

The above heat-resistant resins have high melting points, remain thermally stable and are chemically stable against various chemical agents accompanied, however, by a defect of poor adhesive property to various base materials such as various plastics, metals and glasses. In particular, the aromatic imidazole resin has a larger heat resistance than that of the aromatic imide resin, and exhibits this tendency more conspicuously.

Therefore, various aromatic polyimide resins and aromatic imidazole resins have been proposed improving properties such as adhesive property to various base materials. For example, patent documents 1 to 6 are disclosing aromatic polyimides comprising a recurring unit in which are continuing a structural unit having a heterocyclic ring formed by an imide ring that is condensed with an aromatic ring and a structural unit of an aromatic group, and patent documents 7 and 8 are disclosing polybenzimidazoles having a recurring unit in which are continuing a structural unit having a benzimidazole ring and a structural unit of an aromatic group. In these aromatic polyimide and polybenzimidazole, various substituents (or modifying groups) are introduced into the structural unit of the aromatic group in an attempt to improve various properties.

Patent document 1: JP-A-09-003194

Patent document 2: JP-A-62-048782

Patent document 3: JP-A-09-087388

Patent document 4: JP-A-08-073589

Patent document 5: JP-A-08-208836

Patent document 6: JP-A-2002-080596

Patent document 7: WO/01-048113

Patent document 8: JP-A-2003-105259

### DISCLOSURE OF THE INVENTION

However, the above aromatic polyimides and polybenzimidazoles still have problems such as insufficient adhesive property to various base materials and require cumbersome operation for introducing functional groups for improving properties.

It is, therefore, an object of the present invention to provide a resin composition which comprises, as a chief component, an aromatic imide resin or an aromatic imidazole resin exhibiting markedly improved adhesive property to various base material and which can be easily produced, as well as a method for producing the same.

According to the present invention, there is provided a resin composition comprising:

a heat-treated resin component (A) obtained by heating and mixing a carboxylic acid anhydride and at least one kind of a heat-resistant resin selected from an aromatic imide resin having a recurring structural unit represented by the following formula (1),

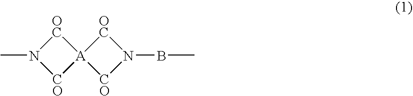

wherein A is a tetravalent organic group, and B is a divalent organic group having an aromatic ring,
   and an aromatic imidazole resin having a recurring structural unit represented by the following formula (2),

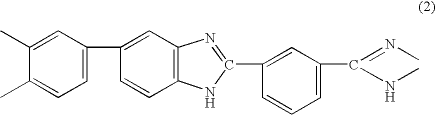

and,

a silane compound (B) having at least one functional group selected from the group consisting of an epoxy group, an amino group, an amide group, a methoxy group, an isocyanate group, a carboxyl group, a mercapto group, a vinyl group, a (poly)sulfide group and a methacrylo group, and having a molecular weight in a range of 100 to 10,000.

In the resin composition of the present invention, it is desired that:

(1) The carboxylic acid anhydride is used in an amount of 1 to 15 parts by mass per 100 parts by mass of the heat-resistant resin, and the silane compound is contained in an amount of 1 to 30 parts by mass per 100 parts by mass of the heat-resistant resin;
(2) In addition to the heat-treated resin component (A), the heat-resistant resin is contained in an amount of 50 to 1,000 parts by mass per the total of 100 parts by mass of the heat-treated component (A) and the silane compound (B); and
(3) An acetylamide organic solvent or a pyrrolidone organic solvent is, further, contained.

According to the present invention, there is further provided a method for producing a resin composition by heating and mixing 100 parts by mass of at least one kind of heat-resistant resin selected from an aromatic imide resin having a recurring structural unit represented by the above formula (1) and an aromatic imidazole resin having a recurring structural unit represented by the above formula (2) with 1 to 15 parts by mass of a carboxylic acid anhydride, and mixing the thus heat-treated product with 1 to 30 parts by mass of the silane compound.

The resin composition of the present invention contains, as a chief component, an aromatic imide resin comprising a recurring structural unit of the above formula (1) or an aromatic imidazole resin comprising a recurring structural unit of the above formula (2). Here, what is particularly important is that the resin composition of the invention contains the above heat-resistant resin as a heat-treated resin component (A) that is heat treated by using a carboxylic acid anhydride together therewith and, further, contains a silane compound (B) having a particular group. That is, the above heat treatment and the blending with a particular silane compound bring about a marked improvement in the adhesive property of the heat-resistant resin as will be demonstrated by Examples appearing later. Though the reason for improving the adhesive property has not yet been clarified, the present inventors presume it as described below.

That is, the aromatic imide resin is obtained by ring-closing a polyamic acid (which has an aromatic ring in which an amino group and a carboxyl group are bonded together) and, hence, part of the polyamic acid is remaining in the aromatic imide resin. When the heat treatment is conducted by using the carboxylic acid anhydride, therefore, the carboxylic acid anhydride reacts with the amino group contained in the polyamic acid, and the dicarboxylic acid is bonded via the amide bond.

The aromatic imidazole resin, on the other hand, includes a secondary amino group (NH group) in the imidazole ring as will be understood from the formula (2). Therefore, when the heat treatment is conducted by using the carboxylic acid anhydride, the carboxylic acid anhydride reacts with the NH group, and, in this case, too, the dicarboxylic acid is bonded via the amide bond.

That is, when either the aromatic imide resin or the aromatic imidazole resin is used, it is considered that the carboxylic acid anhydride is taken into the main chain thereof in the heat-treated component (A) as represented by the following formula,

>N—CO—X—COOH

where carboxylic acid anhydride is denoted by X(CO)₂O.

In the present invention, the heat-treated resin component (A) containing the heat-resistant resin which has the dicarboxylic acid taken into the main chain thereof as described above, is mixed with the silane compound (B). Here, the silane compound (B) is fixed upon reacting with a free carboxyl group in the dicarboxylic acid taken into the main chain. Namely, it is so considered that a particular functional group that imparts adhesive property is fixed in the main chain of the heat-resistant resin via the dicarboxylic acid. Besides, as will be understood from the above description, the silane compound (B) is introduced, via a dicarboxylic acid, into a nitrogen atom of an imide ring or an imidazole ring which is a basic unit portion for exhibiting the properties of the heat-resistant resin. It is, therefore, presumed that the heat-resistant resin exhibits very improved adhesive property. For example, the aromatic imide resins and the aromatic imidazole resins disclosed in the above patent documents 1 to 8 have a functional group or a modifying group introduced into a portion different from the imide ring or the imidazole ring accounting for not so greatly improving the adhesive property.

In the resin composition of the present invention as described above, the heat-resistant resin contained as a chief component exhibits very improved adhesive property to various base materials making it possible to use the resin composition of the invention in a variety of applications where limitation had been imposed on the use of the heat-resistant resins due to their poor adhesive property. Even when the resin composition of the present invention is used for the applications where the heat-resistant resins had been used, excellent properties of the heat-resistant resin contained in the composition can be exhibited sufficiently and reliably owing it its improved adhesive property to the base materials.

Besides, the resin composition of the present invention can be produced relying basically on very simple means by mixing the carboxylic acid anhydride and the silane compound in this order into the heat-resistant resin, without requiring any complex operation for executing a particular reaction, and is very advantageous from the standpoint of productivity and production cost.

### BEST MODE FOR CARRYING OUT THE INVENTION

A resin composition of the present invention is obtained by using an aromatic imide resin or an aromatic imidazole resin as a heat-resistant resin, and by mixing:

a heat-treated resin component (A) obtained by heating and mixing the heat-resistant resin with a carboxylic acid anhydride; and

a silane compound (B) having a particular functional group.

### [Heat-Treated Resin Component (A)]

The aromatic imide resin (hereinafter often abbreviated as PI resin) used for preparing the heat-treated resin component (A) comprises a recurring structural unit represented by the following formula (1),

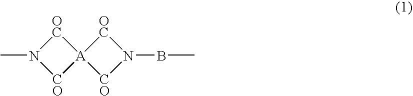

wherein A is a tetravalent organic group and B is a divalent organic group having an aromatic ring.

Concretely, the aromatic imide resin is obtained by the reaction of a tetracarboxylic acid anhydride having the above tetravalent organic group A and an aromatic diamine having the above divalent organic group B that has the aromatic ring.

As the tetravalent organic group A, there can be exemplified a straight-chain or branched-chain aliphatic group, aliphatic cyclic group, aromatic cyclic group and heterocyclic group. As the tetracarboxylic acid anhydride having the above organic group A, there can be exemplified the following compounds:

Butanetetracarboxylic acid dianhydride,

Cyclopentanebutanetetracarboxylic acid dianhydride,

Bicyclotetracarboxylic acid dianhydride,

Pyromellitic acid anhydride,
1,2,3,4-Benzenetetracarboxylic acid dianhydride,
2,3,6,7-Naphthalenetetracarboxylic acid dianhydride,
1,4,5,8-Naphthalenetetracarboxylic acid dianhydride,
1,2,5,6-Naphthalenetetracarboxylic acid dianhydride,
3,4,9,10-Perylenetetracarboxylic acid dianhydride,
2,3,6,7-Anthracenetetracarboxylic acid dianhydride,
1,2,7,8-Phenanthrenetetracarboxylic acid dianhydride,
3,3′,4,4′-Biphenyltetracarboxylic acid dianhydride,
2,2′,3,3′-Biphenyltetracarboxylic acid dianhydride,
3,3′,4,4′-Benzophenonetetracarboxylic acid dianhydride,
2,2′,3,3′-Benzophenonetetracarboxylic acid dianhydride,
2,2-(3,4-Dicarboxyphenyl)propane dianhydride,
Bis(3,4-dicarboxyphenyl)ether dianhydride,
Bis(2,3-dicarboxyphenyl)ether dianhydride,
Bis(3,4-dicarboxyphenyl)sulfone dianhydride,
2,2-Bis(3,4-dicarboxyphenyl)-1,1,1,3,3,3-hexafluoro-propane dianhydride,
2,2-Bis(3,4-dicarboxyphenyl)-1,1,1,3,3,3-hexachloro-propane dianhydride,
1,1-Bis(2,3-dicarboxyphenyl)methane dianhydride,
Bis(3,4-dicarboxyphenyl)methane dianhydride,
4,4′-(p-Phenylenedioxy)diphthalic acid dianhydride,
4,4′-(m-Phenylenedioxy)diphthalic acid dianhydride,
4,4′-Diphenylsulfidedioxybis(4-phthalic acid) dianhydride,
4,4′-Diphenylsulfonedioxybis(4-phthalic acid) dianhydride,
Methylenebis-(4-phenyleneoxy-4-phthalic acid) dianhydride,
Ethylenebis-(4-phenyleneoxy-4-phthalic acid) dianhydride,
Isopropylidenebis-(4-phenyleneoxy-4-phthalic acid) dianhydride,
Hexafluoroisopropylidenebis-(4-phenyleneoxy-4-phthalic acid) dianhydride,
1,2,3,4-Cyclobutanetetracarboxylic acid dianhydride;
1,3-Dimethyl-1,2,3,4-cyclobutanetetracarboxylic acid dianhydride,
1,2,3,4-Cyclopentanetetracarboxylic acid dianhydride;
2,3,5-Tricarboxycyclopentylacetic acid dianhydride;
2,3,4,5-Tetrahydrofuranetetracarboxylic acid dianhydride,
5-(2,5-Dioxotetrahydrofural)-3-methyl-3-cyclohexene-1,2-dicarboxylic acid dianhydride,
Dicyclo[2,2,2]-octo-7-ene-2,3,5,5,6-tetracarboxylic acid dianhydride,
1,2,3,4-Furantetracarboxylic acid dianhydride,
4,4′-Bis(3,4-dicarboxyphenoxy)diphenylsulfide dianhydride,
4,4′-Bis(3,4-dicarboxyphenoxy)diphenylsulfone dianhydride,
4,4′-Bis(3,4-dicarboxyphenoxy)diphenylpropane dianhydride,
3,3′,4,4′-Biphenyltetracarboxylic acid dianhydride,
Bis(phthalic acid)phenylphosfinoxide dianhydride,
p-Phenylene-bis(triphenylphthalic acid) dianhydride,
m-Phenylene-bis(triphenylphthalic acid) dianhydride,
Bis(triphenylphthalic acid)-4,4′-diphenylether dianhydride,
Bis(triphenylphthalic acid)-4,4′-diphenylmethane dianhydride,
1,3,3a,4,5,9b-Hexahydro-2,5-(tetrahydro-2,5-dioxo-3-furanyl)-naphtho[1,2-c]furan-1,3-dione,
1,3,3a,4,5,9b-Hexahydro-5-methyl-5-(tetrahydro-2,5-dioxo-3-furanyl)-naphtho[1,2-c]furan-1,3-dione,
1,3,3a,4,5,9b-Hexahydro-8-methyl-5-(tetrahydro-2,5-dioxo-3-furanyl)-naphtho[1,2-c]furan-1,3-dione, etc.

As the aromatic ring having the divalent organic group B, on the other hand, there can be exemplified a benzene ring, a naphthalene ring and a phenanthrene ring, which may have a suitable substituent such as a halogen atom, an alkyl group or a carboxyl group. The organic group B may be the above aromatic ring group itself, may be a group to which are bonded two benzene rings such as biphenyl, or may be a group represented by the following formula (1a),

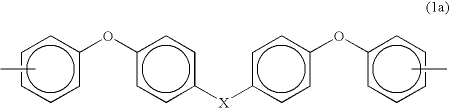

wherein X is an alkylene group.

Described below are concrete examples of the diamine having the above organic group B.
o-Phenylenediamine,
   p-Phenylenediamine,
   m-Phenylenediamine,
4,4′-Diaminophenyl ether,
3,4-Diaminodiphenyl ether,
3,4′-Diaminophenyl ether,
3,3′-Diaminodiphenyl ether;
Bis[4-(3-aminophenoxy)phenyl]sulfide,
Bis[4-(3-aminophenoxy)phenyl]sulfone,
Bis[4-(3-aminophenoxy)phenyl]ketone,
4,4′-Bis(3-aminophenoxy)phenyl]biphenyl,
2,2-Bis[4-(3-aminophenoxy)phenyl]propane,
2,2-Bis[4-(3-aminophenoxy)phenyl]-1,1,1,3,3,3-hexafluoropropane,
4,4′-Diaminodiphenylsulfone,
4,4′-Diaminodiphenylmethane,
1,1-Di(p-aminophenyl)ethane,
2,2-Di(p-aminophenyl)-1,1,1,3,3,3-hexafluoropropane,
1,5-Diaminonaphthalene,
3,3-Dimethyl-4,4′-diaminobiphenyl,
5-Amino-1-(4′-aminophenyl)-1,3,3-trimethylindane,
6-Amino-1-(4′-aminophenyl)-1,3,3-trimethylindane,
4,4′-Diaminobenzanilide,
3,5-Diamino-3′-trifluoromethylbenzanilide,
3,5-Diamino-4′-trifluoromethylbenzanilide,
3,4′-Diaminodiphenyl ether,
2,7-Diaminofluorene,
2,2-Bis(4-aminophenyl)hexafluoropropane,
4,4′-Methylene-bis(2-chloroaniline),
2,2′,5,5′-Tetrachloro-4,4′-diaminobiphenyl,
2,2′-Dichloro-4,4′-diamino-5,5′-dimethoxybiphenyl,
3,3′-Dimethoxy-4,4′-diaminobiphenyl,
4,4′-Diamino-2,2′-bis(trifluoromethyl)biphenyl,
2,2-Bis[4-(4-aminophenoxy)phenyl]propane,
2,2-Bis[4-(4-aminophenoxy)phenyl]hexafluoropropane,
1,4-Bis(4-aminophenoxy)benzene,
4,4-Bis(4-aminophenoxy)biphenyl,
1,3′-Bis(4-aminophenoxy)benzene,
9,9-Bis(4-aminophenyl)fluorene,
4,4′-(p-Phenyleneisopropylidene)bisaniline,
4,4′-(m-Phenyleneisopropylidene)bisaniline,
2,2′-Bis[4-(4-amino-2-trifluoromethylphenoxy)phenyl]hexafluoropropane,
4,4′-Bis[4-(4-amino-2-trifluoromethyl)phenoxy]octafluorobiphenyl, and
1,1-Metaxylenediamine.

That is, the PI resin having the recurring structural unit represented by the above formula (1) is produced by a known method, e.g., produced by suspending or dissolving at least one of the above tetracarboxylic acid dianhydrides and at least one of the above aromatic diamines in an organic solvent so as to react the two to form a polyamic acid, followed by heating and ring-closing (forming a ring).

It is usually desired that the PI resin has the recurring structural units of the above formula (1) in a number of 4 to 100 from the standpoint of various properties.

Further, the aromatic imide resin (hereinafter often referred to simply as PBI resin) comprises a recurring structural unit represented by the following formula (2),

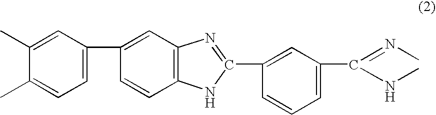

However, the PBI resin comprising the above recurring structural unit has been known as disclosed in, for example, JP-A-2003-105259 (patent document 8 described above). This PBI has a heat resistance considerably higher than that of the above PI resin and, usually, has the recurring structural units in a number of 4 to 100.

The heat-treated resin component (A) used in the present invention is prepared by heating and mixing the above PI resin or the PBI resin and carboxylic acid anhydride together.

As carboxylic acid anhydride, there can be exemplified anhydrous maleic acid, anhydrous phthalic acid, methylphthalic acid anhydride, isophthalic acid anhydride, terephthalic acid anhydride, tetrahydrophthalic acid anhydride, hexahydrophthalic acid anhydride, endomethylenetetrahydrophthalic acid anhydride, endomethylenehexahydrophthalic acid anhydride, trimellitic acid anhydride, pyromellitic acid anhydride, methyltetrahydrophthalic acid anhydride, nadic acid anhydride, methyl nadic acid anhydride, trialkyltetrahydrophthalic acid anhydride, methylhexahydrophthalic acid anhydride, trialkyltetrahydrophthalic acid anhydride/anhydrous maleic acid adduct, dodecinylsuccinic acid anhydride, polyazelaic acid anhydride and polydodecanoic diacid anhydride. Among them, it is particularly desired in the present invention to use anhydrous maleic acid, terephthalic acid anhydride and isophthalic acid anhydride from the standpoint of compatibility, activity of carboxyl group and non-steric hindrance.

The amount of the carboxylic acid anhydride that is used may differ depending upon the number of the recurring structural units possessed by the heat-resistant resin that is used (PI resin or PBI resin) but is, usually, 1 to 15 parts by mass and, particularly, 4 to 12 parts by mass per 100 parts by mass of the heat-resistant resin. If the amount of the carboxylic acid anhydride is smaller than the above range, the adhesive property is not improved to a sufficient degree. If the carboxylic acid anhydride is used in an amount greater than the above range, then properties such as heat resistance inherent in the heat-resistant resin may be impaired. Besides, gelling may occur at the time of heating and mixing, making it difficult to blend other components or making it difficult to carry out forming or coating.

The heat-resistant resin and the carboxylic acid anhydride are heated and mixed by, for example, heating and kneading them together in a semi-molten state or a molten state by using such a kneading machine as a biaxial kneader, an extruder or a heated disper under a heated condition of not lower than 200° C. and, desirably, 300 to 450° C. It is further possible to use a suitable organic solvent; e.g., the heat-resistant resin is dissolved in a predetermined organic solvent to prepare a solution of the heat-resistant resin and into this solution is added the carboxylic acid anhydride, followed by heating at not lower than 70° C. and, particularly, at 90 to 200° C. The above heating and mixing are usually conducted in an inert gas atmosphere.

As the organic solvent that is used as required, further, there is no particular limitation if it is capable of homogeneously dissolving the heat-resistant resin. Generally, there can be exemplified sulfoxide type solvents such as dimethyl sulfoxide and diethyl sulfoxide; formamide type solvents such as N,N-dimethylformamide and N,N-diethylformamide; acetamide type solvents such as N,N-dimethylacetamide and N,N-diethylacetamide; pyrrolidone type solvents such as N-methyl-2-pyrrolidone, N-vinyl-2-pyrrolidone and N-acetyl-2-pyrrolidone; ether type solvents such as tetrahydrofurane, dioxane and dioxolane; cellosolve type solvent such as butyl cellosolve; acetyl carbitol solvent such as sulforane and diethylene glycol ether; ketone type solvents such as methyl ethyl ketone and methyl isobutyl ketone; and alcohol type solvents. These organic solvents can be used in a single kind or being mixed together in two or more kinds. In the present invention, a desired example of the solvent for the PI resin may be a pyrrolidone type solvent and, particularly, an N-methyl-2-pyrrolidone, while a desired example of the organic solvent or the PBI resin may be an acetamide type solvent and, particularly, an N,N-dimethylacetamide or an N,N-diethylacetamide from the standpoint of boiling point and solubility.

According to the present invention, the above heat-resistant resin and the carboxylic acid anhydride are heated and mixed, and it is presumed that dicarboxylic acid is introduced in a manner that one carboxyl group of the dicarboxylic acid is bonded via an amide bond to an imide ring or a benzimidazole ring in the recurring structural unit of the heat-resistant resin. Therefore, it is desired that the above heating and mixing are effected to such a degree that the acid value of the heated mixture becomes lower than an acid value calculated presuming that the dicarboxylic acid (carboxylic acid anhydride) is present in a free form; i.e., usually, it is desired that the heating and mixing are conducted being heated at the above temperature for not shorter than 3 hours.

### [Silane Compound (B)]

In the present invention, a silane compound is added to the heat-treated resin component (A) prepared as described above to thereby obtain a desired resin composition.

The silane compound has a molecular weight in a range of 100 to 10,000 and has, as a functional group, at least one of methoxy group, epoxy group, amino group, isocyanate group, carboxy group, mercapto group, vinyl group, (poly) sulfide group and methacrylo group, and has been known as a so-called silane coupling agent.

That is, the above silane compound is methoxysilane represented, for example, by the following general formula (3),

R₄₋ₙ—Si(OMe)ₙ (3)
wherein Me is a methyl group, R is an alkyl group, an alkenyl group or a phenyl group which may have a substituent, and n is an integer of 1 to 4,
   or is a functional alkoxysilane represented by the following general formula (4),

R¹ₘ—Si(OR²)₄₋ₘ (4)
wherein R¹ is a monovalent organic group, and at least one group R¹ is an organic group having the above functional group (excluding, however, methoxy group), R² is an alkyl group which may have a substituent, and m is an integer of 1 to 3.

Described below are concrete examples.

### Methoxysilanes:

Si(OMe)₄, MeSi(OMe)₃, Me₂Si(OMe)₂, Me₃Si(OMe), C₂H₅Si (OMe)₃, n-C₃H₇Si (OMe)₃, n-C₆H₁₃Si (OMe)₃, n-C₁₀H₂₁Si(OMe)₃, CH₂═CHSi(OMe)₃, C₆H₅Si(OMe)₃, (C₆H₅)₂Si (OMe)₂, (NH₂CH₂CH₂NHCH₂CH₂CH₂)MeSi(OMe)₂, HSCH₂CH₂CH₂Si (OMe)₃, C₆H₅NHCH₂CH₂CH₂Si(OMe)₃, CH₂═C(Me)COOCH₂CH₂CH₂Si (OMe)₃, etc.

### Epoxy Group-Containing Silanes:

γ-Glycidoxypropyltrimethoxysilane,
γ-Glycidoxypropyltriethoxysilane,
γ-Glycidoxypropylmethyldimethoxysilane,
β-(3,4-Epoxycyclohexyl)ethyltrimethoxysilane,
γ-Glycidoxypropylmethyldiethoxysilane, etc.

### Amino Group-Containing Silanes:

γ-Aminopropyltrimethoxysilane,
γ-Aminopropylmethyldimethoxysilane,
γ-Aminopropylmethyldiethoxysilane,
γ-Ureidopropyltrimethoxysilane,
N-β(Aminoethyl)γ-aminopropylmethyldimethoxysilane,
N-β(Aminoethyl)γ-aminopropyltrimethoxysilane,
N-β(Aminoethyl)-γaminopropyltriethoxysilane,
N-Phenyl-γ-aminopropyltrimethoxysilane, etc.

### Isocyanate Group-Containing Silanes:

γ-Isocyanatepropyltrimethoxysilane,
γ-Isocyanatepropyltriethoxysilane,
γ-Isocyanatepropylmethyldiethoxysilane,
γ-Isocyanatepropylmethyldiethoxysilane,
γ-Isocyanatepropyltrimethoxysilane,
γ-Isocyanateethyltriethoxysilane,
γ-Isocyanateethylmethyldiethoxysilane, etc.

### Carboxy Group-Containing Silanes:

β-Carboxyethyltriethoxysilane,
β-Carboxyethylphenylbis(2-methoxyethoxy)silane,
N-β-(Carboxymethyl)aminoethyl-γ-aminopropyl-trimethoxysilane, etc.

### Mercapto Group-Containing Silanes:

γ-Mercaptopropyltrimethoxysilane,
γ-Mercaptopropyltriethoxysilane,
γ-Mercaptopropylmethyldimethoxysilane,
γ-Mercaptopropylmethyldiethoxysilane, etc.

### (Poly)Sulfide Group-Containing Silane Compounds:

Bis(triethoxysilylpropyl)tetrasulfide,
Bis(triethoxysilylpropyl)disulfide, etc.

### Vinyl Group-Containing Silanes:

Vinyltrichlorosilane,

Vinyltrimethoxysilane,

Vinyltriethoxysilane,

Vinyltris(β-methoxyethoxy)silane, etc.

### Methacrylo Group-Containing Silanes:

γ-Methacryloxypropylmethyldimethoxysilane,
γ-Methacryloxypropyltrimethoxysilane,
γ-Methacryloxypropylmethyldiethoxysilane,
γ-Methacryloxypropylethoxysilane, etc.

Among the above silane compounds, it is desired in the present invention to use, particularly, a silane compound having an amino group, an epoxy group, a mercapto group or a sulfide group from the standpoint of improving adhesive property to various base materials.

Namely, in the present invention, it is considered that the above silane compound (B) is stably fixed upon reacting with the free carboxyl group present in the heat-treated resin component (A) achieving markedly improved adhesive property.

It is desired that the silane compound (B) is used in an amount in a range of 1 to 30 parts by mass and, particularly, 3 to 20 parts by mass per 100 parts by mass of the heat-resistant resin. If the amount of the silane compound is smaller than the above range, the adhesive property may not be improved as desired. If the silane compound is used in amounts larger than the above range, then bleed out (bleeding) may occur or properties such as heat resistance inherent in the heat-resistant resin may be spoiled, without increasing the effect for improving adhesive property and without offering any distinguished advantage, which is a disadvantage in cost and the like.

### [Other Blending Agents]

The resin composition of the present invention prepared as described above may be blended with known blending agents.

For example, the resin composition of the present invention may be blended with various coupling agents in addition to the silane compounds (B) having the functional groups so far as the adhesive property does not decrease or the properties of the heat-resistant resin do not decrease. As the coupling agents, the following titanium coupling agents can be exemplified.

Titanium coupling agents:
Isopropyltriisostearoyl titanate,
Isopropyltris(dioctylpyrophosphate)titanate,
Isopropyltri(N-aminoethyl-aminoethyl)titanate,
Tetraoctylbis(ditridecylphosphite)titanate,
Tetra(2,2-diallyloxymethyl-1-butyl)bis(ditridecyl)phosphite titanate,
Bis(dioctylpyrophosphate)oxyacetate titanate,
Bis(dioctylpyrophosphate)ethylene titanate,
Isopropyltrioctanoyl titanate,
Isopropyldimethacrylisostearoyl titanate,
Isopropyltridodecylbenzenesulfonyl titanate,
Isopropylisostearoyldiacryl titanate,
Isopropyltri(dioctylphosphate) titanate,
Isopropyltricumylphenyl titanate,
Tetraisopropylbis(dioctylphosphite) titanate, etc.

The resin composition of the present invention may be further blended with the above heat-resistant resin (PI resin or PBI resin) in addition to the heat-treated resin component (A). Upon being blended with the heat-resistant resin, properties such as heat resistance of the heat-resistant resin can be exhibited to a sufficient degree and, besides, the adhesive property to various base materials can be improved. When blended with the heat-resistant resin in addition to the heat-treated resin component (A), it is desired that the amount of the heat-resistant resin separately blended is 50 to 1,000 parts by mass per a total of 100 parts by mass of the heat-treated component (A) and the silane compound (B).

It is further desired that the resin composition of the present invention is blended with an organic solvent to improve formability, coating property and kneading with other components. The organic solvent may be the one exemplified in the section of the heat-treated resin component (A) described above, and may be used in an amount in a range of 10 to 500 pars by mass per the total of 100 parts by mass of the heat-treated component (A) and the silane compound (B).

The resin composition of the present invention may be further blended with various additives depending upon the applications within a range in which it does not impair the adhesive property to various base materials and properties of the heat-resistant resin. Examples of the additives may include heat stabilizer, dispersant, viscosity-adjusting agent, drip-preventing agent, surface tension-adjusting agent, slip additive, de-foaming agent, flame-retarding agent, antistatic agent, electric conductivity-imparting agent, ultraviolet ray absorber, sensitizer to ultraviolet rays, antibacterial/antimolding/aseptic, antioxidant, chelating agent, organic filler (including fibers), inorganic filler, fluorescent agent, perfume and pigment. These additives may be used in a single kind or in a combination of two or more kinds. The amount of adding the additives may vary depending upon their kind but is, usually, 0.01 to 100 parts by mass, preferably, not larger than 50 parts by mass and, more preferably, not larger than 20 parts by mass per 100 parts by mass of the heat-resistant resin in the resin composition.

The resin composition of the present invention exhibits excellent properties inherent in the heat-resistant resin and, further, exhibits excellent adhesive property to various base materials, and can, therefore, be suitably applied to formed articles that feature excellent electric insulation, heat resistance, resistance against chemicals, formability and dimensional stability, and to the protection films therefor, such as resist material, electrically insulating protection films, over-coating material, optical member, substrate for recording medium and resin for molding IC packages. Particularly, the resin composition of the present invention can be suitably used for the following applications.

(a) The resin composition of the present invention is applied onto one surface or both surfaces of a core film of a heat-resistant resin, as required, via an adhesive layer and, thereafter, an electrically conducting metal foil (e.g., a copper foil, a copper alloy foil, an iron/nickel alloy foil or an aluminum foil) of a thickness of 15 to 40 μm is stuck to the coated surface to use the film as a tape for FPC (flexible printed wiring board) or a tape for TAB for ICs and LSIs. In this case, a polyimide film or a polybenzimidazole film is suited as the core film. As the heat-resistant adhesive, there may be used polyimide, epoxy-modified polyimide, phenol resin-modified epoxy resin, epoxy-modified acrylic resin or epoxy-modified polyamide.
(b) The resin composition of the present invention is applied to the surfaces of a metallic base material or a plastic base material to form a protection film having heat resistance, resistance against chemicals and electrically insulating property.
(c) The circuit-forming surface of an IC or an LSI semiconductor chip forming a plurality of electrodes is molded with the resin composition of the present invention to realize a semiconductor device featuring improved heat resistance, resistance against chemicals, dimensional stability and electrically insulating property.
(d) A resin-covered cable (or a covered electric wire) is coated with the resin composition of the present invention by dipping or spraying to improve the heat resistance, resistance against chemicals and electrically insulating property.
(e) The surfaces of a transfer belt or a fixing belt of an electrophotographic image-forming machine is coated with the resin composition of the present invention to improve the heat resistance.
(f) The glass substrate is coated with the resin composition of the present invention to use it as a substrate for supporting a liquid crystalline oriented film having heat resistance, dimensional stability and optical transparency.
(g) The resin composition of the present invention can be blended as a vehicle in an organic coating material to improve the heat resistance and insulation of the coated film.

### EXAMPLES

The invention will now be described below by way of Examples. However, it should be noted that the invention is in no way limited to these Examples only.

In the following Examples and Comparative Examples, the adhesive property of the resin composition was evaluated as described below.

### Evaluation of Adhesive Property:

Evaluated by the tessellate-peeling testing method (JIS K 5400).

That is, the sample resin composition was applied onto an aluminum plate in a manner that the thickness of the coated film was 10 μm followed by drying at 150° C. for 10 minutes. Thereafter, the heat treatment was conducted at 250° C. for one hour to form the film. The film was engraved with a groove of a width of 1 mm like a tessellate (100 frames). Next, a cellophane tape was stuck to the film and was closely adhered thereto. Thereafter, the cellophane tape was peeled off, and the adhesive property was evaluated depending upon the number of the frames that were not peeled off on the following basis.

⊚: 100/100

◯: 85 to 99/100

Δ: 65 to 84/100

X: 0 to 64/100

### Example 1

A dimethylacetamide solution (PBIMR Solution manufactured by Clariant Japan Co. containing 10% of dimethyl acetamide) was provided containing an aromatic imidazole resin having a recurring structural unit represented by the above formula (2) (PBI resin having the recurring structural units in a number of 260) as the heat-resistant resin.

Into a flask of a volume of one litter equipped with a thermometer, a nitrogen introduction pipe and a reflux condenser, there were introduced the above PBI resin solution and an anhydrous maleic acid in an amount of 5 parts by mass per 100 parts by mass of the PBI resin, followed by purging with nitrogen with stirring. Next, the content in the flask was heated at 95° C. and was maintained at this temperature for 3 hours and was, thereafter, cooled down to room temperature to prepare a heat-treated resin component (A).

Next, a glycidyl group-containing silane compound [KBM-403 manufactured by Shin-Etsu Silicone Co.] was added and mixed in an amount of 3 parts by mass per 100 parts by mass of the PBI resin into the above heat-treated resin component (A) to thereby obtain a resin composition.

The obtained resin composition was evaluated for its adhesive property. The evaluated result thereof and the blending composition of the resin composition were as shown in Table 1.

### Example 2

A resin composition was prepared in quite the same manner as in Example 1 but using the same amount of an amino group-containing silane compound [KBM-603 manufactured by Shin-Etsu Silicone Co.] instead of using the glycidyl group-containing silane compound. The evaluated result of the adhesive property and the blending composition thereof were as shown in Table 1.

### Example 3

A resin composition was prepared in quite the same manner as in Example 1 but using the same amount of a mercapto group-containing silane compound [KBM-803 manufactured by Shin-Etsu Silicone Co.] instead of using the glycidyl group-containing silane compound. The evaluated result of the adhesive property and the blending composition thereof were as shown in Table 1.

### Example 4

A resin composition was prepared in quite the same manner as in Example 1 but changing the amount of the glycidyl group-containing silane compound into 1 part by mass. The evaluated result of the adhesive property and the blending composition thereof were as shown in Table 1.

### Example 5

A resin composition was prepared in quite the same manner as in Example 1 but changing the amount of the glycidyl group-containing silane compound into 15 parts by mass. The evaluated result of the adhesive property and the blending composition thereof were as shown in Table 1.

### Example 6

A polyamic acid was formed by adding a bicyclo(2,2,2)octo-7-ene-2,3,5,6-tetracarboxylic acid anhydride to a solution obtained by dissolving a 3,5-diaminobenzoic acid in an N-methyl-2-pyrrolidone in an amount of 1:1 equivalent. The polyamic acid that was separated was dissolved again in the N-methyl-2-pyrrolidone and to which a γ-butyl lactone and a pyridine were added, followed by heating to dehydrate and close the ring to thereby prepare a polyimide resin solution having a number average molecular weight of 100,000 (solution containing 10% of N-methyl-2-pyrrolidone).

A resin composition was prepared in quite the same manner as in Example 1 but using the solution of the polyimide resin (PI resin). The evaluated result of adhesive property of the obtained resin composition and the blending composition thereof were as shown in Table 1.

### Comparative Example 1

An attempt was made to prepare a heat-treated resin component (A) in the same manner as in Example 1 but changing the amount of the anhydrous maleic acid into 30 parts by mass resulting, however, in the occurrence of gelling and making it difficult to blend the silane compound.

### Comparative Example 2

A resin composition was prepared in quite the same manner as in Example 1 but changing the amount of the glycidyl group-containing silane compound into 0.1 part by mass. The evaluated result of adhesive property of the obtained resin composition and the blending composition thereof were as shown in Table 1.

### Comparative Example 3

A resin composition was prepared without using anhydrous maleic acid but by mixing the glycidyl group-containing silane compound directly into a solution of the PBI resin in an amount of 3 parts by mass per 100 parts by mass of the PBI resin. The evaluated result of adhesive property of the obtained resin composition and the blending composition thereof were as shown in Table 1.

TABLE 1

| | Composition of resin composition (mass parts) | | | | | |
|---|---|---|---|---|---|---|
| | Heat-treated resin | | | | | |
| | component (A) | | | | | |
| | | Anhydrous | Silane compound (B) | | | Adhesive |
| | PBI | maleic acid | Glycidylsilane | Aminosilane | Mercaptosilane | property |
| Ex. 1 | 100 | 5 | 3 | | | ⊚ |
| Ex. 2 | 100 | 5 | | 3 | | ⊚ |
| Ex. 3 | 100 | 5 | | | 3 | ⊚ |
| Ex. 4 | 100 | 5 | 1 | | | ◯ |
| Ex. 5 | 100 | 5 | 15 | | | ⊚ |
| Ex. 6 | 100 (PI) | 5 | 3 | | | ⊚ |
| Comp. Ex. 1 | 100 | 30 | gelled | gelled | gelled | gelled |
| Comp. Ex. 2 | 100 | 5 | 0.1 | | | X |
| Comp. Ex. 3 | 100 | — | 3 | | | X |

Glycidylsilane: KBM 403, aminosilane: KBM 603, mercaptosilane: KBM 803

### Applied Experiment.

Into 100 parts by mass of the resin composition prepared in Example 1, the PBI resin used for the preparation thereof was mixed in an amount of 100 parts by mass, and the adhesive property thereof was evaluated to be Δ.

When the amount of the PBI resin mixed into the resin composition was changed into 50 parts by mass, the adhesive property thereof was evaluated to be ◯.

Further, when the amount of the PBI resin mixed into the resin composition was changed into 2000 parts by mass, the adhesive property thereof was evaluated to be X.

1. A resin composition comprising:
a heat-treated resin component (A) obtained by heating and mixing a carboxylic acid anhydride and at least one kind of a heat-resistant resin selected from an aromatic imide resin having a recurring structural unit represented by the following formula (1), 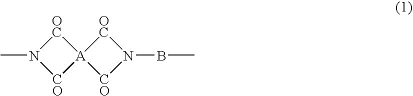
wherein A is a tetravalent organic group, and B is a divalent organic group having an aromatic ring,
and an aromatic imidazole resin having a recurring structural unit represented by the following formula (2), 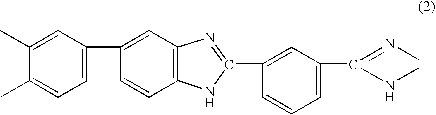
and,
a silane compound (B) having at least one functional group selected from the group consisting of an epoxy group, an amino group, an amide group, a methoxy group, an isocyanate group, a carboxyl group, a mercapto group, a vinyl group, a (poly)sulfide group and a methacrylo group, and having a molecular weight in a range of 100 to 10,000.

2. The resin composition according to claim 1, wherein said carboxylic acid anhydride is used in an amount of 1 to 15 parts by mass per 100 parts by mass of said heat-resistant resin, and said silane compound is contained in an amount of 1 to 30 parts by mass per 100 parts by mass of said heat-resistant resin.

3. The resin composition according to claim 2, wherein in addition to said heat-treated resin component (A), said heat-resistant resin is contained in an amount of 50 to 1,000 parts by mass per the total of 100 parts by mass of said heat-treated component (A) and the silane compound (B).

4. The resin composition according to claim 1, wherein an acetylamide organic solvent is, further, contained.

5. A method for producing a resin composition by heating and mixing 100 parts by mass of at least one kind of heat-resistant resin selected from an aromatic imide resin having a recurring structural unit represented by the following formula (1), 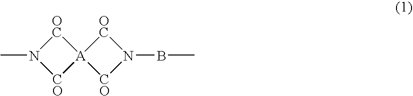
wherein A is a tetravalent organic group, and B is a divalent organic group having an aromatic ring,
and an aromatic imidazole resin having a recurring structural unit represented by the following formula (2), 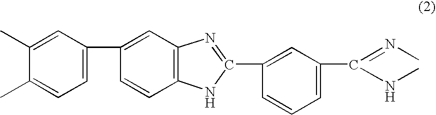
with 1 to 15 parts by mass of a carboxylic acid anhydride, and mixing the thus heat-treated product with 1 to 30 parts by mass of a silane compound having at least one functional group selected from the group consisting of an epoxy group, an amino group, an amide group, a methoxy group, an isocyanate group, a carboxyl group, a mercapto group, a vinyl group, a (poly)sulfide group and a methacrylo group, and having a molecular weight in a range of 100 to 10,000.
